(19) United States
(12) Patent Application Publication
(10) Pub. No.: US 2004/0089825 A1
(43) Pub. Date: May 13, 2004

(54) Apparatus for converting a continuous liquid stream to a stream of liquid droplets

(76) Inventors: Heinrich Schwenke, Escheburg (DE); Joachim Knoth, Lauenburg (DE); Eckard Jantzen, Hamburg (DE)

Correspondence Address: Klaus Bach, 4407 Twin Oaks Drive, Murrysville, PA, 15668, US

(21) Appl. No.: 10/655,605

(22) Filed: Sep. 4, 2003

(30) Foreign Application Priority Data
Sep. 5, 2002 (DE) 102 41 545.5

(51) Int. Cl. G01N 15/06; G01N 21/49

(52) U.S. Cl. 250/573

(57) ABSTRACT

In an apparatus for the conversion of a continuous liquid stream into a stream of liquid droplets, which are discharged from a discharge nozzle of the capillary through which the liquid stream is conducted, a flow acceleration device is disposed on the capillary near the discharge nozzle thereof for accelerating the droplet stream depending on a first electrical signal, which is applied to the acceleration device, and a second electrical signal which is generated by a laser detection means provided for sensing laser light of a beam directed through the travel path of the droplets to the detection means for sensing the passage of a droplet and means for generating from the first and second electrical signals a time Δt which indicates the time needed for a liquid droplet to travel from the discharge nozzle to the laser light beam.

### BACKGROUND OF THE INVENTION

The invention relates to an apparatus for the conversion of a continuous liquid stream to a stream of liquid droplets.

A timely and loss-free conversion of a liquid stream to a stream of liquid droplets is necessary for example with the element and species analysis of small amounts, or respectively, with the analysis of individual cells or proteins by a so-called “hyphenated technique”. This is an analysis method wherein a molecule-specific separation technique is coupled in real time generally with an mass-spectrometric detection technique.

For analysis, so far, generally a so-called nebulizer is used, that is, an apparatus which converts a liquid stream into a series of nebula clouds which consist of a large number of droplets.

An important disadvantage of a nebulizer is, that the liquid stream is divided into a collection of droplets and not into time and space-wise exactly defined individual droplets. This known nebulizer technique has essentially three disadvantages: first, the amount to be analyzed is relatively large that is a relatively large sample amount so that a high separation definition of the hyphenated technique and the detection quality of the combined method are required. On the other hand, the spatial expansion of the nebula cloud is relatively large in comparison with an individual droplet so that large losses occur during the transfer of the sample to a mass spectrometer. Finally, the point of time of the entrance of a droplet cloud into a mass spectrometer cannot be determined in a precise manner.

Inspite of accurate preparations of analysis techniques which employ the droplet method, no droplet generator is presently known, which satisfactorily eliminates the disadvantages referred to above. With the presently known analysis techniques to convert a very small liquid stream into a stream of a series of droplets over a sufficiently long period quantitatively without losses and without the use of a buffer volume. Known droplet generators are extremely sensitive to pressure changes. It has, for example, so far not been possible, to couple a so-called HPLC (high pressure liquid chromatography) separation method) or, respectively, CE equipment (capillary electrophoresis) with a droplet generator without losses, since already minimal changes of the flow volume prevent the continuous generation of droplets without spare or buffer volumes.

It is therefore the object of the present invention to provide an apparatus for converting a continuous liquid stream to a stream of liquid droplets in such a precise manner that a predetermined amount of liquid droplets per time unit is continuously generated and liquid droplets can be formed with a predetermined frequency so that the droplet-forming capillary techniques can be performed with mass spectrometers, that is a very small, clearly defined, liquid stream can be divided over a predetermined sufficiently long period quantitatively and loss-free into a series of droplets.

### SUMMARY OF THE INVENTION

In an apparatus for the conversion of a continuous liquid stream to a stream of liquid droplets, which are discharged from a discharge nozzle of a capillary through which the liquid stream is conducted, a flow acceleration device is disposed on the capillary near the discharge nozzle thereof for accelerating the droplet stream depending on a first electrical signal applied to the acceleration device, a laser detection means is provided for sensing laser light of a beam directed through the travel path of the droplets to the detection means for sensing the passage of a droplet and generating thereby a second electrical signal and means for generating from the first and second electrical signals a time Δt, which indicates the time needed for a liquid droplet to travel from the discharge nozzle to the laser light beam and applying a signal to the acceleration device so as to adjust the time Δt to a desired value.

The advantage of the solution according to the invention resides in the fact that it does not have the disadvantages of the techniques used so far for such purposes. With the apparatus according to the invention, the capillary-guided liquid stream can be converted, without buffer volume, into a sequence of equal-size droplets. As desired, with the invention, a time-stable and loss-free conversion of a quasi-continuous liquid stream into a stream of liquid droplets of a predetermined amount and predetermined frequency is obtained.

Preferably, the apparatus according to the invention is so designed that, when the time Δt>a predetermined time t_{N}, the distance of at least two subsequent electrical signals is reduced until Δt=t_{N}.

t_{N} is determined by t_{N}=V_{T}/T_{γ}, wherein V_{T} is the volume of the droplets and T_{γ} is the volume of the droplet stream, that is, the volume of the liquid which is transported per time unit by the droplet stream.

With suitable electric or, respectively, electronic equipment, a self-controlling system can be provided that is, the time which passes between the exiting of a droplet from the nozzle and its reaching the location of exposure to the laser light is automatically controlled to a predetermined standard time t_{N}. This is equally possible for the number of droplets per time unit (droplet frequency).

In the same way, the apparatus may be operated in such a way that, when the time Δt<a predetermined time t_{N}, the distance between at least two subsequent electrical signals is increased until Δt=t_{N}.

The acceleration apparatus, which must be so designed that it accelerates the discharge of a liquid droplet out of the nozzle of the capillary, may be designed in any way. However, preferably the acceleration apparatus is in the form of a piezo element with which in a simple but highly precise manner an electrically controllable acceleration apparatus can be provided in the area of the discharge nozzle of the liquid capillary.

Below the invention will be described in greater detail with reference to the accompanying schematic drawings.

### BRIEF DESCRIPTION OF THE DRAWINGS

FIG. 1 shows the three basic components of a first embodiment of the invention;

FIG. 2 shows the three basic components of another embodiment of the invention;

FIG. 3 shows a combination of a block diagram and a flow chart of the determination and control circuit of a first embodiment of the apparatus;

FIG. 4 shows a combination of a block diagram and a flow chart of the determination and control circuit of a second embodiment of the apparatus;

FIG. 5 shows schematically the generation of droplets by a droplet generation apparatus of the state of the art and the disadvantages occurring therewith when the capillary stream is greater than the droplet stream; and

FIG. 6 shows schematically the liquid droplet generation as shown in FIG. 5 when the capillary stream is smaller than the droplet stream.

### DESCRIPTION OF A PREFERRED EMBODIMENT

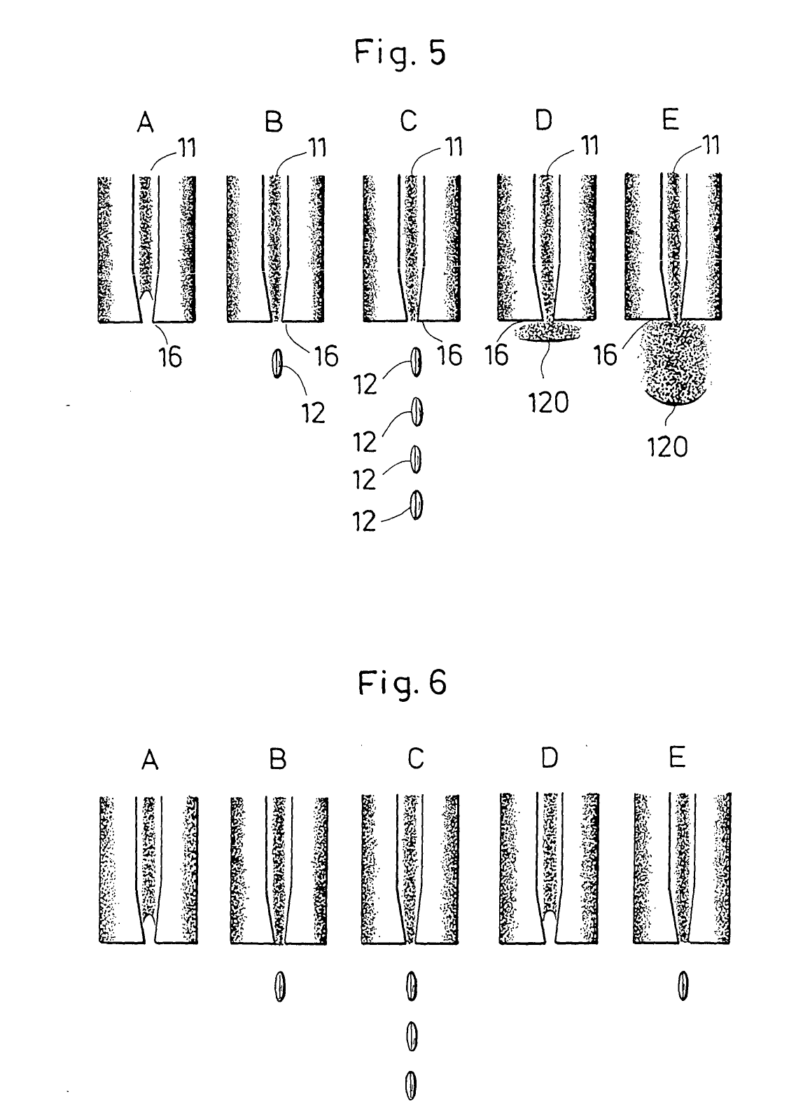

First, reference is made to the representation according to FIG. 5, which shows the conversion of a continuous liquid flow into a stream of liquid droplets 12 as they are generated by means of the known techniques, which however excludes the use of the droplet method in a combined procedure (hyphenated technique).

The prior art method, see FIG. 5, is performed as follows: At the point in time A, the system starts out with an empty discharge nozzle 16. The following liquid stream 11 results, at the point in time B, in the discharge of a first liquid droplet 12. Over a time period C, the system operates correctly, but under the given conditions, T_{c}>T_{γ} wherein T_{c} is the capillary stream and T, is the droplet stream, the conditions shown in FIG. 5, conditions D and E are unavoidable, which cause the system to collapse such that renewed droplet generation without mechanical removal of the giant droplet 120, the conditions D and E and other measures are not possible.

A similar process shown schematically in FIG. 6 is less unstable, but is also not desirable because it is not very effective as it is characterized by a slowing capillary stream (T_{c}εT_{γ}). After the generation of liquid droplets 12 (steps A to C) in step D, the stream of liquid droplets stops and, under the given conditions (T_{c}<T_{γ}) starts again with step E when the liquid stream 11 has again advanced.

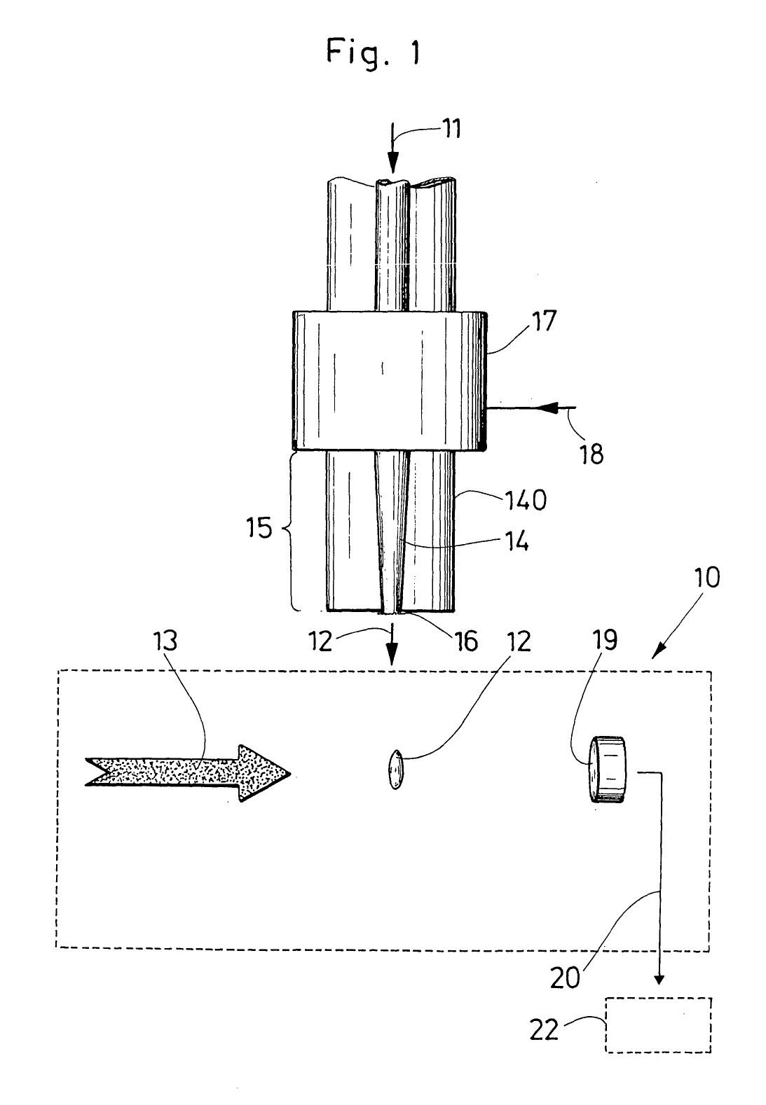

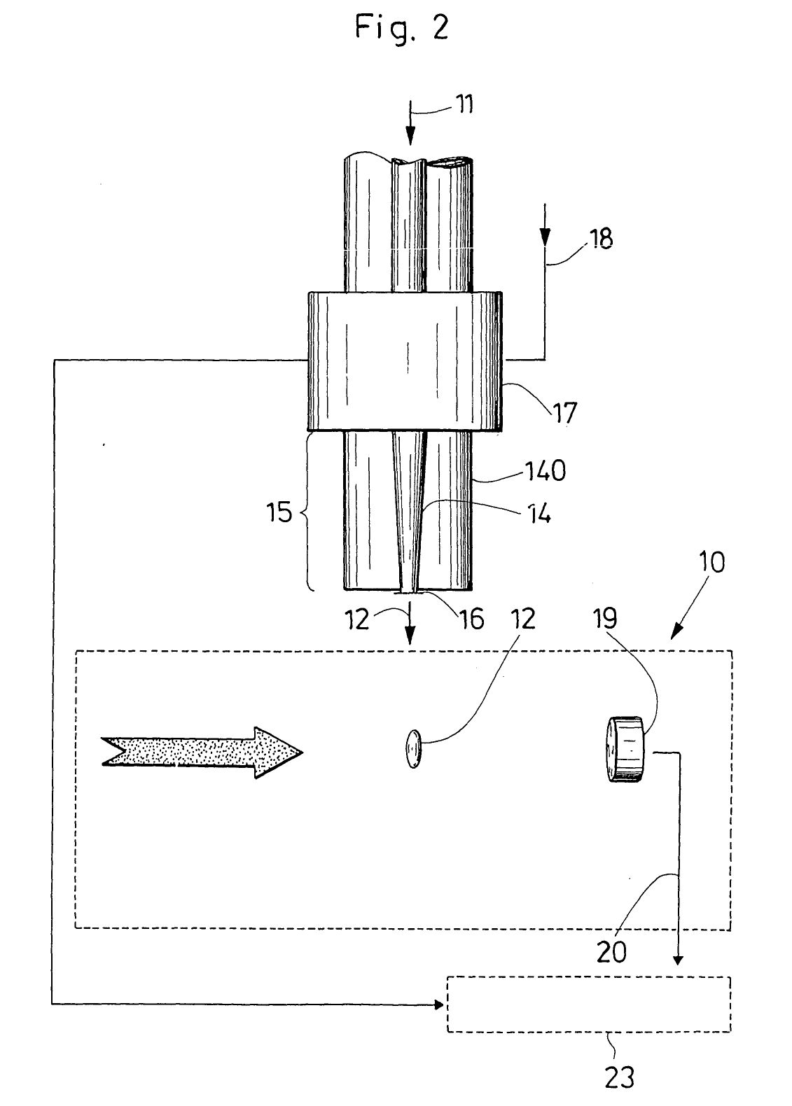

Reference is now made to FIGS. 1 and 2, which show the arrangement according to the invention in a schematic form. Since means for generating capillary liquid streams 11 are well known in the art, those means are not described herein. A capillary liquid stream 11 is introduced into a capillary 14 of a capillary guide tube structure 140, which has a discharge nozzle 16, from which liquid droplets 12 are discharged. In the area of the discharge nozzle 16, there is an acceleration device 17 in the form of a piezo element, which is annular and surrounds the capillary guide tube 140.

A liquid droplet 12 leaving the discharge nozzle 16 moves over a certain distance to the location of an apparatus 10, which is provided to detect the droplet 12, for example, by laser light and to determine the point in time when the droplet 12 passes a predetermined location.

A detector 19 senses when a liquid droplet 12 crosses for example the laser light axis of the detector 19. When the detector 19 recognizes that a liquid droplet 12 crosses the beam of the laser light 13 directed toward the detector 19, a second electrical signal 20 is generated and supplied to a count e r 22. Instead of the counter 22 as shown in FIG. 1, alternatively, a time measuring device 23 as shown in FIG. 2 may be provided.

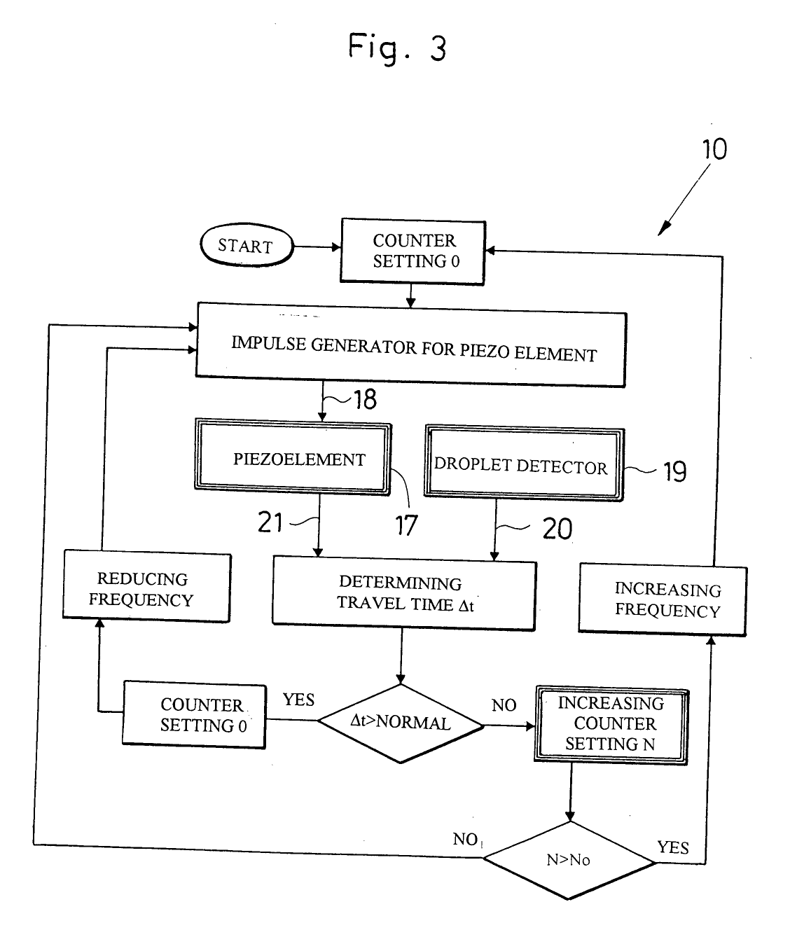

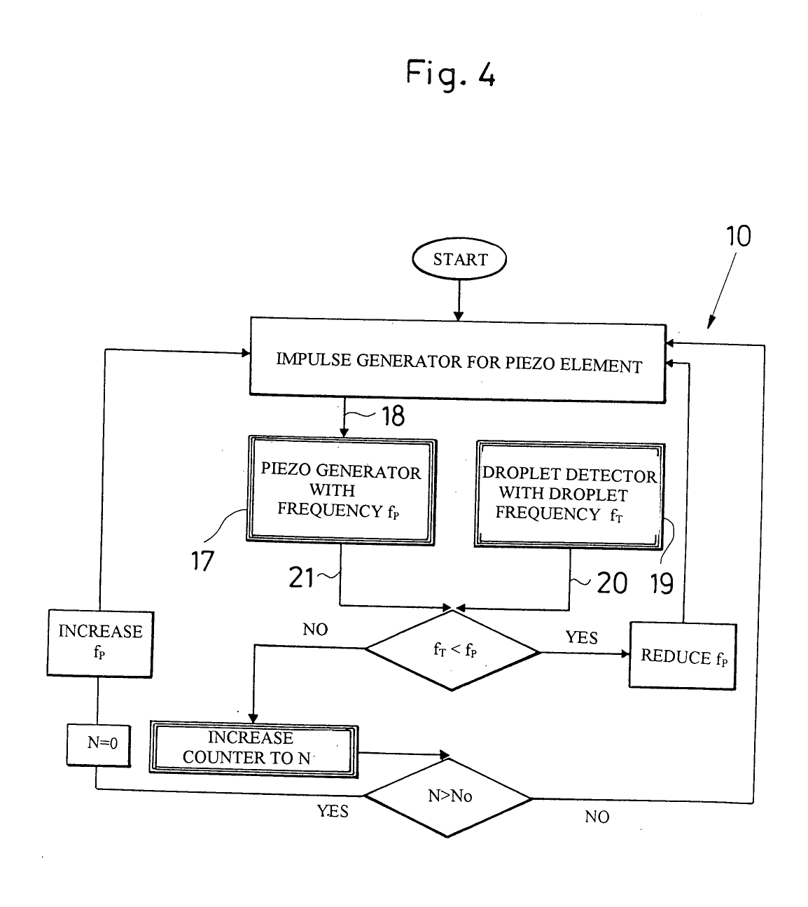

The acceleration device 17, which is in the form of a piezo element, obtains from an impulse or tact generator (see FIGS. 3 and 4), a tact impulse in the form of a electrical signal 18 or, respectively, a first series of electrical signals 18.

The flow charts shown in FIGS. 3 and 4 present the control arrangement of the apparatus 10, which includes electronic control detection and comparison elements which are known in electronic control engineering and which therefore do not need to be described in detail. It is sufficient to describe their operation.

The two main control values for the apparatus 10 according to the invention are the travel time of the liquid droplet 12 as measured by the time difference Δt between the first electrical signal 18, by which the acceleration device 17 is energized and the second electrical signal 20, which is generated by the detector 19, see FIG. 3, or, alternatively, the droplet frequency, that is, the number n of liquid droplets 12, which have passed the droplet detector with a minimal Δt or, alternatively, up to maximum droplet frequency f_{γ} since the start or respectively, the resetting of the counter 22.

By means of the apparatus 10, the process shown in FIG. 5 is avoided which unavoidably occurs when the liquid stream T_{c} is larger over a sufficiently long period than the liquid droplet stream T_{γ}, which is the product of the volumes of the individual droplets VT or respectively, 12 and the number of the droplets per time unit f, (T_{γ}=V_{T}×f_{γ})

In accordance with the invention, the droplet generation by controlling the piezo frequency fₚ as schematically shown in FIGS. 3 and 4 is so controlled that the capillary liquid stream 11 is generally smaller than the (virtual) stream of liquid droplets 12, but so that the condition T_{c}=T_{γ} is approximated over an extended period.

Since with the arrangement according to the invention the travel speed of the liquid droplet 12 is used as a control signal, it is furthermore possible to control the level of the first electrical signal 18, which is present for example as a voltage pulse, that energizes the piezo element 17, depending on the travel time Δt, with the aim to change the travel speed of the liquid droplet 12, or respectively, the distance between the liquid droplets 12 in the chain of liquid droplets leaving the discharge nozzle 16 in a suitable manner.

An other effective method for the adaptation of the piezo frequency to the capillary liquid stream 11 resides in the changing of the speed of the liquid droplet 12. The liquid droplet speed is measured for example by means of a light barrier as shown in FIG. 1, which can be used as input value for the control with the aim to maintain the travel velocity of the liquid droplet 12 at a maximum level.

What is claimed is:

1. An apparatus for the conversion of a continuous liquid stream (11) to a stream of liquid droplets (12), comprising a capillary (14) receiving and guiding the liquid stream (11) and having a discharge nozzle (16), an acceleration device (17) arranged in the area of the discharge nozzle (16) for accelerating the droplet stream out of the discharge nozzle depending on a first electrical signal (18) applied to said acceleration device (17), a laser light detection means (19) for sensing laser light beam (13) directed through the travel path of said droplets to said detection means (19) for sensing the passage of a droplet (12) and generating a second electrical signal (20), means for generating from the first and second electrical signals (18, 20) a time Δt, which indicates the time needed for the liquid droplet (2) to travel from the discharge nozzle to the laser light beam (13), and means for applying a signal to said acceleration device (17) for adjusting the time Δt.

2. An apparatus according to claim 1, wherein said acceleration device (17) is a piezo element.

3. An apparatus according to claim 2, wherein said acceleration device (17) has a piezo frequency fₚ which is constantly compared with the droplet generation frequency f_{γ} and fₚ is so controlled that fₚ=f_{γ}+ε, wherein ε is a small number→0.

4. An apparatus according to claim 3, wherein said piezo frequency is so controlled that the droplet frequency is a maximum.

5. An apparatus according to claim 1, wherein when the Δt between the first and second electrical signals>than a predetermined time t_{N}, the spacing between two subsequent first electrical signals (18) is reduced until Δt=t_{N}−ε, wherein ε is a time approaching zero (ε→O).

6. An apparatus according to claim 1, wherein, when the time Δt<than a predetermined time t_{N} between at least two subsequent first electrical signals (18) is increased until Δt=t_{N}−ε, wherein ε is a time approaching zero (ε→O).
